(19) United States
(12) Patent Application Publication
(10) Pub. No.: US 2021/0355897 A1
(43) Pub. Date: Nov. 18, 2021

(54) FUEL INJECTION DEVICE COMPRISING A NOZZLE INSERT

(71) Applicant: DUNCHA France, Blois Cedex (FR)

(72) Inventors: Anthony Piton, Mer (FR); Pierre-Yves Griveau, Chanceaux sur Choisille (FR)

(21) Appl. No.: 17/320,563

(22) Filed: May 14, 2021

(30) Foreign Application Priority Data
May 14, 2020 (FR) 2004761

(51) Int. Cl. F02M 55/00; F02M 61/18

(52) U.S. Cl. CPC F02M 55/008; F02M 2200/8061; F02M 2200/315; F02M 61/18

(57) ABSTRACT

The invention relates to a fuel injection device for an internal combustion engine, comprising a fuel flow pipe which extends in a flow direction, a nozzle insert, wherein the nozzle insert comprises a cylindrical body which is positioned in the flow pipe, a channel which extends through the cylindrical body from one side to the other; and wherein the cylindrical body successively comprises in the flow direction a fitted portion which is force-fitted in a fitting portion of the flow pipe and a guided portion which is intended to cooperate with a guiding portion of the flow pipe in order to guide the movement of the cylindrical body in the flow pipe before force-fitting, the guided portion comprising an outer diameter which is less than an outer diameter of the fitted portion, and wherein a ratio between the outer diameter of the fitted portion and a dimension of the guided portion in the flow direction is between 0.33 and 1.

### CROSS-REFERENCE TO RELATED APPLICATION

This application claims priority to French Application No. 2004761, filed on May 14, 2020. The entire application is herein incorporated by reference.

### FIELD OF THE INVENTION

The invention relates to the field of common rail injection devices for an internal combustion engine.

### BACKGROUND OF THE INVENTION

Injection devices of the prior art comprise a common rail which has a main chamber, an inlet hole which opens in the main chamber and which is intended to be connected to a fuel supply tube, a plurality of injection wells which are distributed along the common rail and which are each intended to receive an injector and a plurality of pipes which each enable the main chamber to be connected to one of the injection wells.

The injection devices are provided with nozzle inserts which are formed by a reduction of the passage cross section of the fuel in order to generate a pressure loss which enables the pressure waves to be damped. The nozzle inserts of the prior art are formed by an axially perforated cylindrical element which is fitted in the flow pipe which connects the main chamber of the common rail to the injection well. This fitting is particularly difficult to carry out, taking into account in particular the complex tools required to carry out such a fitting in an optimum manner. This is because, during the fitting, it is necessary to ensure that the nozzle insert is inserted along the same axis as the flow pipe so that it is not subjected to excessively powerful constraints during the fitting which may lead to deformation of the nozzle insert or even material being torn out.

In the prior art there are also known nozzles which are directly machined in the common rail. However, this type of insert also requires complex tooling and is particularly difficult to machine particularly as a result of the drill bit lengths which are required.

### SUMMARY

A notion on which the invention is based is to facilitate the insertion of the nozzle insert into the flow pipe whilst ensuring good mechanical strength.

According to an embodiment, the invention provides a fuel injection device for an internal combustion engine comprising:
a fuel flow pipe which extends in a flow direction and which forms a passage cross section of the fuel;
a nozzle insert which is intended to damp the pressure waves in the flow pipe, wherein the nozzle insert comprises:
a cylindrical body which is positioned in the flow pipe,
a channel which extends through the cylindrical body from one side to the other and which enables the passage cross section of the fuel through the flow pipe to be restricted locally; and
   wherein the cylindrical body successively comprises in the flow direction a fitted portion which is force-fitted in a fitting portion of the flow pipe and a guided portion which is intended to cooperate with a guiding portion of the flow pipe in order to guide the movement of the cylindrical body in the flow pipe before the fitted portion is force-fitted, the guided portion comprising an outer diameter which is less than an outer diameter of the fitted portion, and wherein a ratio between the outer diameter of the fitted portion and a dimension of the guided portion in the flow direction is between 0.33 and 1.

As a result of these features, the guided portion enables the insertion of the nozzle insert into the flow pipe to be facilitated by guiding the nozzle insert for the entire length of the fitting operation in order to prevent it from becoming tilted. Thus function is particularly ensured as a result of an optimum size of the guided portion relative to the outer diameter of the fitted portion. This is because the size of the guided portion is sufficiently large compared with the outer diameter of the fitted portion to ensure the correct positioning in the flow pipe, whilst preventing the dimensions of the guided portion from being excessively large, which would lead to an unnecessarily bulky component.

The expression “force-fitted” means that the contained component, in this instance the fitted portion, is adjusted in a state clamped in the containing component, in this instance the fitting portion of the flow pipe. That is to say that, before insertion, the contained component has an outer diameter which is strictly greater than the inner diameter of the containing component. Consequently, it is necessary to apply sufficient force to place the contained component in the containing component.

According to embodiments, such an injection device may comprise one or more of the following features.

According to an embodiment, the cylindrical body is cylindrical with a circular base.

According to an embodiment, the channel is cylindrical, preferably with a circular base.

According to an embodiment, the flow pipe is at least partially cylindrical, preferably with a circular base.

According to an embodiment, a ratio between the outer diameter of the fitted portion and a dimension of the fitted portion in the flow direction is between 0.75 and 2.5.

According to an embodiment, a ratio between the outer diameter of the fitted portion and a dimension of the fitted portion in the flow direction is between 0.75 and 1.

In this manner, this ratio enables the nozzle insert to have sufficiently large dimensions to have good mechanical strength for force-fitting, whilst requiring a reasonable fitting force.

According to an embodiment, the cylindrical body has a revolution axis and the guiding portion is cylindrical and has a guiding diameter and a revolution axis, and a guiding play, equal to the difference between the outer diameter of the guided portion and the guiding diameter of the guiding portion, is configured so that the revolution axis of the cylindrical body forms an angle with the revolution axis of the guiding portion between 0 and 5 degrees when the fitted portion of the cylindrical body is force-fitted in the fitting portion of the flow pipe.

According to an embodiment, the guiding play is configured so that the revolution axis of the cylindrical body forms an angle with the revolution axis of the guiding portion between 0 and 3 degrees, preferably between 0 and 2 degrees, preferably between 0 and 1 degree, when the fitted portion of the cylindrical body is force-fitted in the fitting portion of the flow pipe.

According to an embodiment, the guiding play is between 0 and 0.225 mm.

According to an embodiment, the guiding play is between 0 and 0.225 mm at the radius.

In this manner, the guiding play enables the nozzle insert to be readily guided in the flow pipe whilst ensuring that it is not fitted in a tilted manner in the flow pipe.

According to an embodiment, the fitting portion of the flow pipe comprises a fitting diameter, the fitting diameter being greater than the guiding diameter of the guiding portion.

According to an embodiment, the fitting portion of the flow pipe comprises a fitting diameter, the fitting diameter being equal to the guiding diameter. In this embodiment, the fitting portion is defined by the zone in which the fitted portion is fitted, whilst the guiding portion extends after this zone.

According to an embodiment, the dimension of the guided portion of the cylindrical body in the flow direction is greater than the dimension of the fitting portion of the flow pipe in the flow direction.

In this manner, this enables the guided portion to be located at least partially in the guiding portion before the fitting of the cylindrical body begins in order to ensure that the guiding serves to position the cylindrical body in the axis of the flow pipe.

According to an embodiment, the dimension of the guided portion of the cylindrical body in the flow direction is greater than, at least 1.5 times, the dimension of the fitting portion of the flow pipe in the flow direction.

According to an embodiment, a ratio between a dimension of the fitted portion in the flow direction and the dimension of the guided portion in the flow direction is between 0.1 and 0.5.

According to an embodiment, the flow pipe has, in an insertion direction of the nozzle insert in the flow pipe, a chamfered inlet portion, the fitting portion and the guiding portion.

In this manner, the chamfered inlet portion enables facilitated insertion of the cylindrical body in the flow pipe.

According to an embodiment, the channel is a stepped bore produced in the cylindrical body and formed by at least a first bore and a second bore, the first bore being located in the region of the fitted portion and comprising a diameter less than the second bore.

According to an embodiment, the channel is cylindrical.

According to an embodiment, the cylindrical body of the nozzle insert comprises at one side and the other of the fitted portion a first portion and a second portion, the guided portion being formed by the first portion or the second portion in accordance with the insertion direction of the nozzle insert into the flow pipe.

According to an embodiment, the second portion is formed in an identical manner to the first portion in order to form a symmetrical cylindrical body.

### BRIEF DESCRIPTION OF THE FIGURES

The invention will be better understood and other objectives, details, features and advantages thereof will be appreciated more clearly from the following description of a number of specific embodiments of the invention, given purely by way of non-limiting example, with reference to the appended drawings, in which:

FIG. 1 is a sectioned view of an injection device according to an embodiment.

FIG. 2 is a view of the detail II of FIG. 1 illustrating a flow pipe and a nozzle insert according to an embodiment before insertion in the flow pipe.

FIG. 3 is a view of the detail II of FIG. 1 illustrating a flow pipe and a nozzle insert according to an embodiment during the guiding.

FIG. 4 is a view of the detail II of FIG. 1 illustrating a flow pipe and a nozzle insert according to an embodiment after fitting.

FIG. 5 is a view of the detail II of FIG. 1 illustrating a flow pipe and a nozzle insert according to another embodiment after fitting.

### DESCRIPTION OF THE EMBODIMENTS

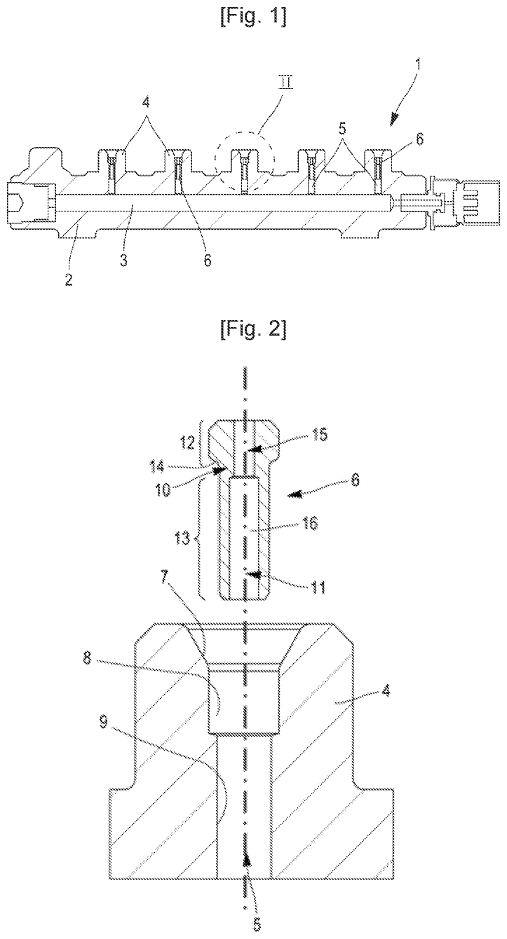

FIG. 1 illustrates an injection device which is generally designated 1. The injection device 1 comprises a common rail 2 which extends in a longitudinal direction. The common rail 2 is hollow and thus defines a tubular main chamber 3 which is illustrated in FIG. 1 and which extends in the longitudinal direction of the common rail 2. The common rail 2 is advantageously produced in one piece, for example, using a forging method.

The common rail 2 comprises an inlet hole which opens in the main chamber 3 of the common rail 2 and which is intended to be connected to a fuel supply tube which is not illustrated.

Furthermore, the common rail 2 comprises injection wells 4 which are each intended to receive an injector (not illustrated). Each of the injection wells 4 extends in a transverse direction perpendicular to the longitudinal direction. The injection wells 4 thus open in the main chamber 3. In other words, the axis of each injection well 4 passes through the main chamber 3.

Each injection well 4 comprises a fuel flow pipe 5 which extends through the injection well 4 from one side to the other so that the flow pipe 5 opens in the main chamber 3. The flow pipe 5 thus forms a fuel passage cross section in the injection well 4.

Furthermore, the injection device 1 comprises a nozzle insert 6 which is located in each flow pipe 5 of the injection wells 4. The nozzle insert 6 is intended to reduce the passage cross section of the fuel between the inlet of the injection well 4 and the outlet of the injection well 4. The nozzle insert 6 thus generates a pressure loss which enables the pressure waves to be damped. The nozzle insert 6 is intended to be force-fitted in the flow pipe 5 in a fitted position.

FIGS. 2 to 4 illustrate in a more detailed manner a first embodiment of a nozzle insert 6 and a flow pipe 5 of an injection well 4.

In FIG. 2, the nozzle insert 6 is illustrated before insertion into the flow pipe 5 which enables in particular the different portions of the flow pipe 5 to be distinguished more easily.

In the first embodiment, the flow pipe 5 is formed in a stepped manner and comprises from the inlet of the injector well 4 to the main chamber 3 a chamfered inlet portion 7, a fitting portion 8 having a fitting diameter and a guiding portion 9 which has a guiding diameter. The chamfered inlet portion 7 is produced in a frustoconical manner, the fitting portion 8 and the guiding portion 9 are produced in a cylindrical manner with a circular cross section. Using its frustoconical shape, the chamfered inlet portion 7 produces a sealing zone in order to connect the flow pipe to a high-pressure tube.

The chamfered inlet portion 7, the fitting portion 8 and the guiding portion 9 are aligned with each other in order to have the same revolution axis. The chamfered inlet portion 7 serves to assist the operator to insert the nozzle insert 6 into the flow pipe 5 by increasing the diameter of the flow pipe 5 at the inlet. The functions of the fitting portion 8 and the guiding portion 9 will be explained in detail below.

In the first embodiment, the nozzle insert 6 itself comprises a cylindrical body 10 and a channel 11 which extends through the cylindrical body from one side to the other. The channel 11 thus having a smaller passage cross section than the flow pipe 5 enables a pressure loss to be generated and enables the pressure waves to be damped.

As can be seen in FIGS. 2 to 4, the cylindrical body 10 is formed by a single monobloc element and successively comprises a fitted portion 12 and a guided portion 13. The fitted portion 12 comprises an outer diameter which is larger than the guided portion 13, the fitted portion 12 being connected to the guided portion by means of a fillet 14.

The channel 11 is a stepped bore which is produced in the cylindrical body 10 and formed by at least a first bore 15 and a second bore 16 which has a larger diameter than the first bore 16. The first bore 15 is located substantially in the region of the fitted portion 12 whilst the second bore is located in the region of the guided portion 13. It is substantially the first bore 15 which acts as the pressure loss in the nozzle insert 6. The first bore 15 is thus produced with precision by means of machining taking into account the deformation by means of compression as a result of the force-fitting of the nozzle insert 6. A very precise bore over the entire length of the nozzle insert 6 not being required, the second bore 16 is produced by means of machining with less precision in order to simplify the production of the nozzle insert 6. In a variant, the first bore 15 may also be produced by means of machining after the nozzle insert 6 has been fitted.

The advantage of placing the first bore 15 in the region of the fitted portion 12 of the cylindrical body 12 is that the fitted portion 12 is prestressed in terms of compression into the fitted position thereof. In this manner, the pressure waves extend through the flow pipe 5, the first bore 15 with the prestressing thereof is more resistant in particular in the radial direction of the cylindrical body 10 and therefore expands less readily. This is because the expansion of the first bore could reduce the efficiency of the nozzle insert 6 for damping the pressure waves.

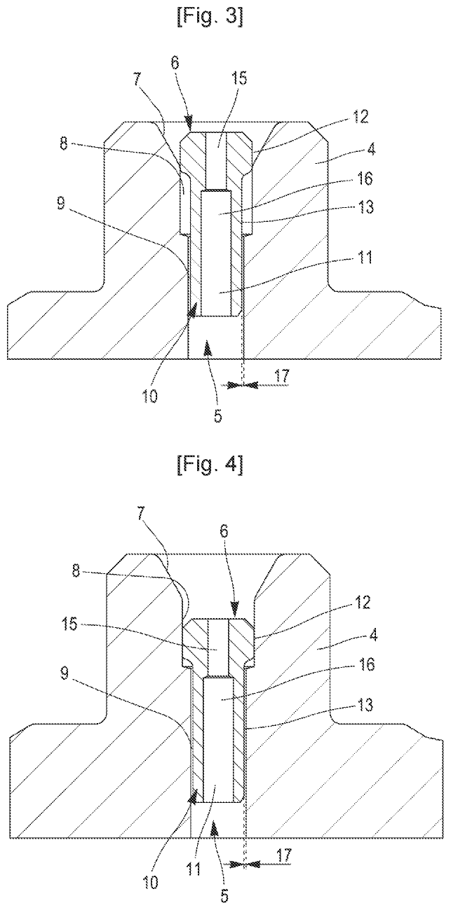

FIG. 3 also illustrates the first embodiment, the nozzle insert 6 this time being in a guiding step in the flow pipe 5.

As set out above, the cylindrical body 10 comprises a guided portion 13 which serves to guide the nozzle insert 6 in the flow pipe 5 in order to prevent tilting. This is because, during the insertion in the flow pipe 5, the guided portion 13 cooperates with the guiding portion 9 of the flow pipe 5 in order to guide the movement of the cylindrical body 10 in the flow pipe 5 before the fitted portion 12 is force-fitted. To this end, the difference between the outer diameter of the guided portion 13 and the guiding diameter of the guiding portion 9, referred to below as guiding play 17, is produced so that the revolution axis of the cylindrical body 10 forms an angle with the revolution axis of the guiding portion preferably between 0 and 2 degrees. In this manner, the nozzle inert 6 is correctly aligned with the flow pipe before the fitting step which particularly prevents the injection well and the nozzle insert from becoming damaged during force-fitting.

FIG. 4 also illustrates the first embodiment, the nozzle insert 6 being force-fitted in the flow pipe 5 into the final position thereof, which may or may not be in abutment.

To this end, the nozzle insert 6 is pushed into the flow pipe 5 so that the fitted portion 12 of the nozzle insert 6 cooperates with the fitting portion 8 of the flow pipe 5. In order to ensure that the nozzle insert 6 also remains correctly aligned during the fitting, the guided portion 13 continues to be guided in the guiding portion 9.

In this embodiment, the flow pipe 5 is stepped in three portions of different diameters. This is because the chamfered inlet portion 7 comprises a diameter which decreases in the introduction direction of the nozzle insert 6 in order to facilitate the positioning operation of the nozzle insert 6. Furthermore, the fitting portion 8 of the flow pipe comprises a fitting diameter and the guiding portion 9 comprises a guiding diameter. As seen above, the guiding diameter is produced in correlation with the diameter of the guided portion 13 in order to obtain a guiding play 17 which is sufficiently small to enable the nozzle insert 6 to be aligned with the flow pipe 5. The fitting diameter is in this instance strictly greater than the guiding diameter in order to correctly dissociate the two portions of the flow pipe 5. Furthermore, this enables a cylindrical body 10 of the nozzle insert 6 to be obtained which has a diameter of the fitted portion 12 which is much larger than that of the guided portion 13. In order to be able to carry out force-fitting, the diameter of the fitted portion 12 has a diameter which is slightly greater than the fitting diameter of the flow pipe 5.

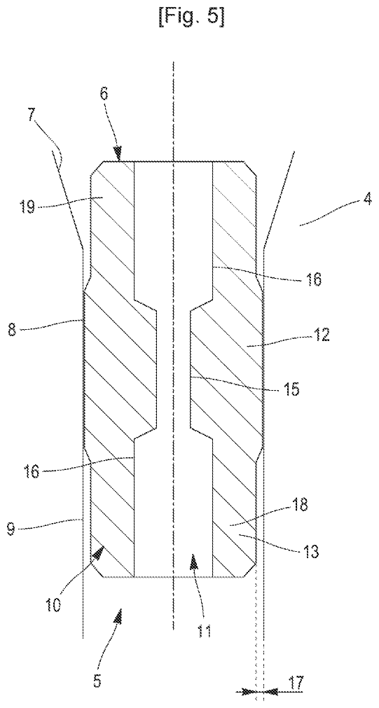

FIG. 5 illustrates a second embodiment, in which the nozzle insert 6 is force-fitted in the flow pipe 5. This embodiment differs from the first embodiment in terms of the design of the cylindrical body 10 and of the flow pipe 5.

In this second embodiment, the flow pipe 5 is stepped only in two portions of different diameters. This is because the chamfered inlet portion 7 remains the same as in the first embodiment. However the guiding diameter and the fitting diameter are in this instance identical so that the guiding portion 9 and the fitting portion 8 are distinguished from each other only by means of a different function. Consequently, the fitted portion 12 and the guided portion 13 of the cylindrical body have diameters which are closer to each other than in the first embodiment. Furthermore, the cylindrical body 10 comprises in this instance at one side and the other of the fitted portion 12 a first portion 18 and a second portion 19 which is formed in an identical manner to the first portion 18. In FIG. 5, the nozzle insert 6 has been inserted with the first portion 18 first into the flow pipe so that in this illustration the guided portion 13 is formed by the first portion 18 whilst the second portion 19 may be used to manipulate/grip the nozzle insert 6 during the guiding and the fitting. However, the presence of a first portion 18 and a second portion 19 at each of the ends of the fitted portion 12 allows the nozzle insert 6 to be able to be inserted in any direction, the portion inserted first into the flow pipe acting as a guide.

In another embodiment which is not illustrated, the nozzle insert 6 could be produced as in the first embodiment whilst the flow pipe 5 would be produced as in the second embodiment.

In the same manner, in another embodiment which is not illustrated, the nozzle insert 6 could be produced as in the second embodiment whilst the flow pipe 5 would be produced as in the first embodiment.

In another embodiment which is not illustrated, the flow pipe 5 does not comprise a chamfered inlet portion 7 but only a fitting portion 8 and a guiding portion 9.

Although the invention has been described in connection with several specific embodiments, it is evident that it is by no means limited thereto and it includes all the technical equivalents of the means described and the combinations thereof if they are included within the scope of the invention.

The use of the verb “have”, “comprise” or “include” and the conjugated forms thereof does not exclude the presence of elements or steps other than those set out in a claim.

In the claims, any reference numeral in brackets should not be interpreted to be a limitation of the claim.

1. Fuel injection device for an internal combustion engine, comprising:—a fuel flow pipe which extends in a flow direction and which forms a passage cross section of the fuel; and—a nozzle insert which is intended to damp the pressure waves in the flow pipe, wherein the nozzle insert comprises:—a cylindrical body which is positioned in the flow pipe,—a channel which extends through the cylindrical body from one side to the other and which enables the passage cross section of the fuel through the flow pipe to be restricted locally; and wherein the cylindrical body successively comprises in the flow direction a fitted portion which is force-fitted in a fitting portion of the flow pipe and a guided portion which is intended to cooperate with a guiding portion of the flow pipe in order to guide the movement of the cylindrical body in the flow pipe before the fitted portion is force-fitted, the guided portion comprising an outer diameter which is less than an outer diameter of the fitted portion, and wherein a ratio between the outer diameter of the fitted portion and a dimension of the guided portion in the flow direction is between 0.33 and 1.

2. Fuel injection device according to claim 1, wherein a ratio between the outer diameter of the fitted portion and a dimension of the fitted portion in the flow direction is between 0.75 and 1.

3. Fuel injection device according to claim 1, wherein the cylindrical body has a revolution axis and the guiding portion is cylindrical and has a guiding diameter and a revolution axis, and wherein a guiding play, equal to the difference between the outer diameter of the guided portion and the guiding diameter of the guiding portion, is configured so that the revolution axis of the cylindrical body forms an angle with the revolution axis of the guiding portion between 0 and 5 degrees when the fitted portion of the cylindrical body is force-fitted in the fitting portion of the flow pipe.

4. Fuel injection device according to claim 3, wherein the guiding play is between 0 and 0.225 mm.

5. Fuel injection device according to claim 3, wherein the fitting portion of the flow pipe comprises a fitting diameter, the fitting diameter being greater than the guiding diameter of the guiding portion.

6. Fuel injection device according to claim 1, wherein the dimension of the guided portion of the cylindrical body in the flow direction is greater than the dimension of the fitting portion of the flow pipe in the flow direction.

7. Fuel injection device according to claim 1, wherein a ratio between a dimension of the fitted portion in the flow direction and the dimension of the guided portion in the flow direction is between 0.1 and 0.5.

8. Fuel injection device according to claim 1, wherein the flow pipe has, in an insertion direction of the nozzle insert in the flow pipe, a chamfered inlet portion, the fitting portion and the guiding portion.

9. Fuel injection device according to claim 1, wherein the channel is a stepped bore produced in the cylindrical body and formed by at least a first bore and a second bore, the first bore being located in the region of the fitted portion and comprising a diameter less than the second bore.

10. Fuel injection device according to claim 1, wherein the cylindrical body of the nozzle insert comprises at one side and the other of the fitted portion a first portion and a second portion, the guided portion being formed by the first portion or the second portion in accordance with the insertion direction of the nozzle insert into the flow pipe.

11. Fuel injection device according to claim 2, wherein the cylindrical body has a revolution axis and the guiding portion is cylindrical and has a guiding diameter and a revolution axis, and wherein a guiding play, equal to the difference between the outer diameter of the guided portion and the guiding diameter of the guiding portion, is configured so that the revolution axis of the cylindrical body forms an angle with the revolution axis of the guiding portion between 0 and 5 degrees when the fitted portion of the cylindrical body is force-fitted in the fitting portion of the flow pipe.

12. Fuel injection device according to claim 4, wherein the fitting portion of the flow pipe comprises a fitting diameter, the fitting diameter being greater than the guiding diameter of the guiding portion.

13. Fuel injection device according to claim 2, wherein the dimension of the guided portion of the cylindrical body in the flow direction is greater than the dimension of the fitting portion of the flow pipe in the flow direction.

14. Fuel injection device according to claim 3, wherein the dimension of the guided portion of the cylindrical body in the flow direction is greater than the dimension of the fitting portion of the flow pipe in the flow direction.

15. Fuel injection device according to claim 4, wherein the dimension of the guided portion of the cylindrical body in the flow direction is greater than the dimension of the fitting portion of the flow pipe in the flow direction.

16. Fuel injection device according to claim 5, wherein the dimension of the guided portion of the cylindrical body in the flow direction is greater than the dimension of the fitting portion of the flow pipe in the flow direction.

17. Fuel injection device according to claim 2, wherein a ratio between a dimension of the fitted portion in the flow direction and the dimension of the guided portion in the flow direction is between 0.1 and 0.5.

18. Fuel injection device according to claim 3, wherein a ratio between a dimension of the fitted portion in the flow direction and the dimension of the guided portion in the flow direction is between 0.1 and 0.5.

19. Fuel injection device according to claim 4, wherein a ratio between a dimension of the fitted portion in the flow direction and the dimension of the guided portion in the flow direction is between 0.1 and 0.5.

20. Fuel injection device according to claim 5, wherein a ratio between a dimension of the fitted portion in the flow direction and the dimension of the guided portion in the flow direction is between 0.1 and 0.5.
